(19) United States
(12) Patent Application Publication
(10) Pub. No.: US 2018/0187465 A1
(43) Pub. Date: Jul. 5, 2018

(54) REVERSIBLE HINGE AND REINFORCED HINGE ASSEMBLY

(71) Applicant: INTER-JOIN PTY LTD, Abbotsbury, New South Wales (AU)

(72) Inventor: Tom BERTOVIC, Abbotsbury, New South Wales (AU)

(21) Appl. No.: 15/739,714

(22) PCT Filed: Jun. 25, 2016
(86) PCT No.: PCT/AU2016/000224

§ 371 Date: Dec. 23, 2017

(30) Foreign Application Priority Data
Jun. 25, 2015 (AU) 2015100850
Jun. 26, 2015 (AU) 2015100842

(51) Int. Cl. E05D 7/02; E05D 3/02; E05D 5/04

(52) U.S. Cl. CPC E05D 7/02; E05Y 2900/132; E05D 5/04; E05D 3/02

(57) ABSTRACT

A hinge includes an elongate connecting knuckle to which a door flange and frame flanges are pivotably attached. The door flange has a plurality of symmetrically located screw holes such that the screw holes are in alignment with screw holes formed in a door in use with the frame flange disposed on either side of the door, resulting in a reversible hinge enabling the door swing to be changed from a left-hand to a right-hand door swing or vice versa. The hinge is for use with a hinge reinforcement plate or stand-off plate which includes end portions and a centre portion offset relative to the end portions. Hollow self-clinching spacer pieces extend from the underside of the stand-off plate. The spacer pieces include internal threads and are embedded into the door frame in use and provides means for securing hinge screws through the door frame.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to metal hinges and more particularly hinges used to hang doors to a door frame. In particular, the invention relates to a reversible hinge, and a reinforced hinge assembly comprising the reversible hinge and a reinforcement plate.

### 2. Description of Related Art Including Information Disclosed Under 37 CFR 1.97 and 37 CFR 1.98.

The hinge art is well developed and hinges can be found in a wide variety of shapes, sizes and mechanical interactions. Mounting of a door in a door frame generally requires a skilled person to properly align and recess the hinges to the required depth ensuring a properly closing door with accurate door gaps.

The current hinge design used for timber doors does not allow for surface mounting, and as such once the hinge recess is made, the door swing is restricted according to the hinge placement and the door swing cannot be reversed.

Fitting or hanging doors in door frames generally requires a skilled person to properly align and recess the hinges to the required depth ensuring a properly closing door with accurate door gaps. The doors are secured to the door frame with screws being inserted through the hinge mounting holes, directly into the door frame material.

When inserting the screws, the amount or torque used to drive the screws determines the effectiveness of the screws to provide the required clamping pressure. If the screws are not inserted with enough torque, the hinge fixing is not tight, and if the torque is too high, the screw fixing can be compromised as once the screw reaches maximum depth, the screw will spin without any grip, damaging the parent material.

Furthermore, should a door need to be removed and refitted, reinserting the screws in the same screw holes requires slightly more torque to regain the previous pressure. Increasing the torque of the screws increased the potential to damage the parent material resulting in complete failure of the screw.

Door sizes have been increasing, resulting in heavier doors essentially being supported on a door frame that has essentially remained the same, both in thickness and the material used. However the pressure on the screws supporting these heavier doors has increased requiring higher torque settings for a tight fitment.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a hinge comprising an elongate connecting knuckle to which at least one door flange and at least one frame flange are pivotably attached, the connecting knuckle extending along aligned side edges of the door flange and the frame flange, wherein the door flange has a plurality of symmetrically located screw holes such that the screw holes are in alignment with screw holes formed in a door in use with the frame flange disposed on either side of the door, resulting in a reversible hinge enabling the door swing to be changed from a left-hand to a right-hand door swing or vice versa.

In one embodiment, the hinge comprises two frame flanges, wherein the flanges are generally rectangular flat plates with the door flange disposed between the two frame flanges.

In another embodiment, in the open position of the hinge, rear faces of the flanges face the same direction, the rear faces of the flanges comprising protruding deformation screw holes to provide positive location of the hinge to screw holes in the door and door frame.

In another embodiment, the screw holes in the frame flange are disposed symmetrically.

In another embodiment, the door flange and frame flanges are separated by freely rotating bearings located within the connecting knuckle.

In another embodiment, in the closed position, the rear faces of the door flanges and frame flange face opposing directions.

In another embodiment, the rear faces of the door flange and the frame flange in the closed position are spaced from each other by off-set distance.

In another embodiment, the front faces of the door flange and frame flange comprise countersunk screw holes.

In another embodiment, the door flange and frame flange are generally equally sized flat plates with the door flange disposed above the frame flange.

In another embodiment, the connecting knuckle comprises a removable pin centrally located between the door flange and the frame flange to allow the door flange to be separated from the frame flange.

The present invention also provides a reinforced hinge assembly comprising:
the hinge of any one of the above, wherein the frame flange is to be disposed to one side of a door frame, and
a reinforcement plate to be disposed to an opposite side of the door frame, the reinforcement plate comprising a shaped plate having a plurality of hollow internally threaded spacer pieces aligned with the screw holes of the frame flange, wherein the spacer pieces are embedded into the door frame in use and provides means for securing hinge screws through the door frame.

In one embodiment, the spacer pieces are self-clinching.

In another embodiment, the reinforcement plate comprises end portions and centre portion offset relative to the end portions, wherein the spacer pieces extend from the end portions.

In another embodiment, a number of hexagonal heads are embedded into the surface of the end portions respectively aligned with the spacer pieces.

According to a first aspect, the preferred embodiment provides an improvement on the conventional designed metal hinges by incorporating two pivotally interconnected hinge flanges with symmetrically located screw holes that allow for the hinge to be reversible.

In a preferred embodiment, the hinge also eliminates the need to recess the hinge flanges by incorporating off-set flanges that allow for the hinges to be surface mounted, making installation comparatively simple with an accurate and consistent closed hinge dimension.

In another preferred embodiment, the hinge flanges contain protruding deformation screw holes at the rear face of the flange provide positive locating by tightly fitting to the corresponding screw holes in the door and frame respectively.

In another preferred embodiment, the protruding deformations being tightly fitting within corresponding screw holes in the door and frame respectively spread the load through the hinge, removing the shear load off the individual screws.

In another preferred embodiment, this invention uses a second door flange as a frame flange to secure to the frame. A removable pin located within the central pivoting knuckle enables the hinge to be converted into a lift-off hinge resulting in easy separation of the hinge flanges.

In a preferred embodiment, the present invention provides an improvement on the conventional method of door hinge installation by incorporating a stand-off plate containing a number of self clinching spacer pieces with machined thread inserts.

In a preferred embodiment, the present invention also guarantees precisely aligned screws and eliminate the possibility of skewed screw heads resulting from poorly inserted screws.

In another preferred embodiment, this invention allows for unlimited removal and refitting of screws with no risk of stripping the screw thread or damaging the parent material that would otherwise support the screws.

In another preferred embodiment, this invention increases the fixing strength of the hinge and door jamb by pulling the stand-off plate and hinge tightly together to spread the load through the plate and remove the shear load off the individual screws.

In another preferred embodiment, this invention eliminates the need to have different and specific screw threads, by requiring only one specific machined screw thread, no matter what the parent material is made from.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a top view of a reversible hinge in an open position.

FIG. 2 is a front view of the reversible hinge in an open position.

FIG. 3 is a first side view of the reversible hinge in an open position showing the door frame flanges.

FIG. 4 is a second side view of the reversible hinge in an open position showing the door flange.

FIG. 5 is a top view of the reversible hinge in a closed position.

FIG. 6 is a front view of the reversible hinge in a closed position.

FIG. 7 is a side view of the reversible hinge in a closed position.

FIG. 8 is an isometric view of the reversible hinge in an open position.

FIG. 9 is an isometric view of the reversible hinge in a closed position.

FIG. 10 is a close-up isometric view of the lower portion reversible hinge showing the flange off-set.

FIG. 11 is a top view of an alternate reversible hinge in an open position.

FIG. 12 is a front view of the alternate reversible hinge in an open position

FIG. 13 is a first side view of the alternate reversible hinge showing the door flange.

FIG. 14 is a second side view of the alternate reversible hinge showing the frame flange.

FIG. 15 is a top view of the alternate reversible hinge in a closed position.

FIG. 16 is a front view of the alternate reversible hinge in a closed position.

FIG. 17 is a side view of the alternate reversible hinge in a closed position.

FIG. 18 is an isometric view of the alternate reversible hinge in an open position.

FIG. 19 is an isometric view of the alternate reversible hinge in a closed position.

FIG. 20 is a close-up isometric view of the lower portion of the alternate reversible hinge showing the flange off-set.

FIG. 21 shows a hinge face of a steel door.

FIG. 22 shows attachment of the reversible hinge to the door with the frame flanges extending to one side of the door.

FIG. 23 shows attachment of the reversible hinge to the door with the frame flanges extending to the other side of the door.

FIG. 24 is a top view of a reinforcement plate.

FIG. 25 is a front view of the reinforcement plate.

FIG. 26 is a side view of the reinforcement plate.

FIG. 27 is a rear side isometric view of the reinforcement plate.

FIG. 28 is a front side isometric view of the reinforcement plate.

FIG. 29 is an exploded top cross-section view of a reinforced hinge assembly and a door frame section.

FIG. 30 is a top cross-section view of the reinforced hinge assembly mounted to the door frame section.

FIG. 31 is an isometric view corresponding to FIG. 29.

FIG. 32 is an isometric view corresponding to FIG. 30.

### DETAILED DESCRIPTION OF THE INVENTION

It should be noted in the following description that like or the same reference numerals in different embodiments denote the same or similar features.

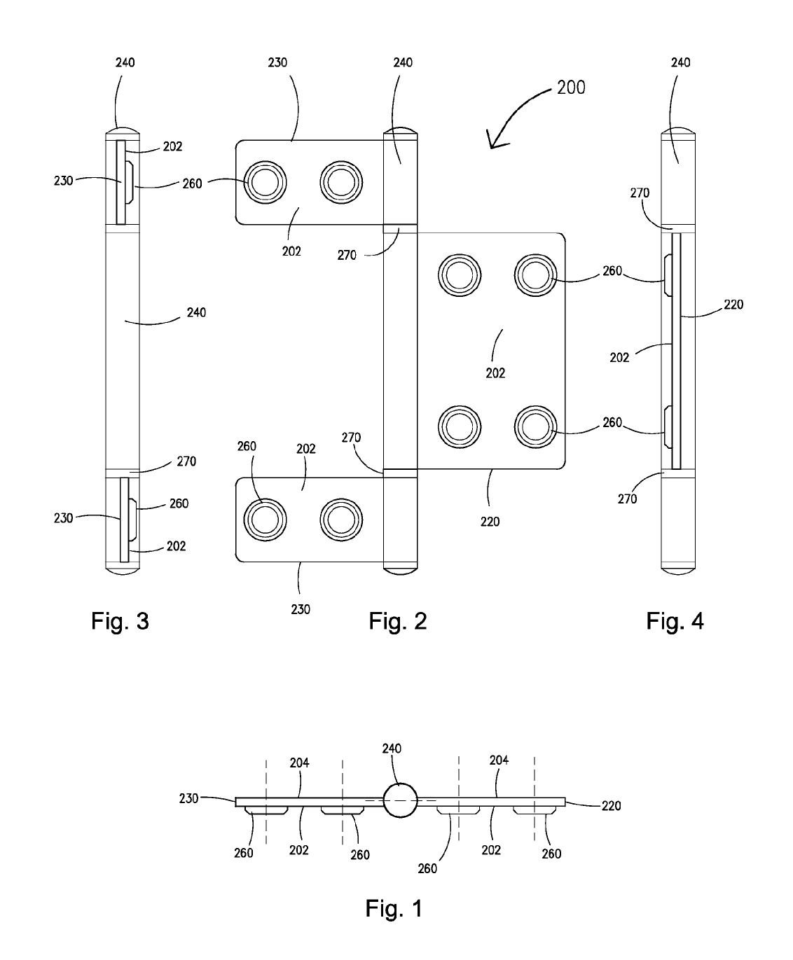

FIGS. 1 to 10 show a metal hinge 200 according to a preferred embodiment of the present invention. The hinge 200 comprises an elongate connecting knuckle 240 to which a door flange 220 and two frame flanges 230 are pivotably attached. The flanges are generally rectangular flat plates with the larger door flange 220 disposed between the two smaller frame flanges 230. The connecting knuckle extends along aligned common side edge of the flanges 220 and 230 such that the flanges are pivotable in the horizontal direction in use. The flanges 220 and 230 are thus disposed in a substantially contiguous manner, with small spacing between adjacent flanges.

FIG. 1, shows a top view of the metal hinge 200, in an open position, with the connecting knuckle 240 centrally located between the opposing door flange 220 and the two frame flanges 230. In the open position, the rear faces 202 of the flanges 220 and 230 face the same direction. The rear faces 202 of the flanges 220 and 230 contain protruding deformation screw holes 260, to provide positive location of the hinge 200 to screw holes in the door and door frame. The screw holes 260 in the door flange 220 are disposed symmetrically. In the embodiment, the screw holes 260 are disposed in a square pattern.

FIG. 2, shows a front view of the metal hinge 200 being in an open position, showing the rear faces 202 of both the door flange 220 and the frame flanges 230 with protruding deformation screw holes 260. The door flange 220 and frame flanges 230 are separated by freely rotating bearings 270 located within the connecting knuckle 240.

FIGS. 3 and 4 show opposite side views of the frame flanges 230 and door flanges 220 with protruding deformation screw holes 260 for positive location.

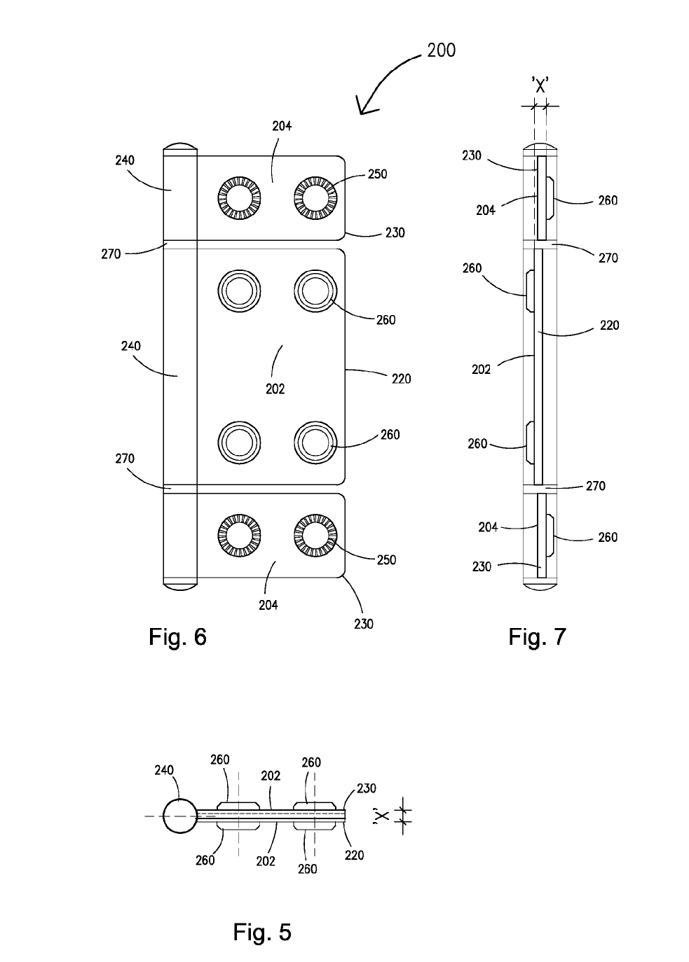

FIG. 5, shows a top view of the metal hinge 200, in a closed position, with the connecting knuckle 240 extending along common side edges of both door flange 220 and the frame flanges 230. In the closed position, the rear faces 202 of the flanges 220 and 230 face opposing directions. The rear faces 202 of the flanges 220 and 230 in the closed position are spaced from each other by off-set ‘X’ that allows for surface mounting of the hinges, whilst maintaining an accurate closed hinge dimension door gap. That is, the flanges 220 ad 230 are not aligned in the closed position of the hinge.

FIG. 6, shows a front view of the metal hinge 200 being in a closed position, showing the rear face 202 of door flange 220 with protruding deformation screw holes 260, together with the front faces 204 of the frame flanges 230 with countersunk screw holes 250. The door flange 220 and the frame flanges 230 are separated by freely rotating bearings 270 located within the connecting knuckle 240.

FIG. 7 shows the side view of the closed hinge with door flange 220 and frame flanges 230 with protruding deformation screw holes 260. The screw holes 260 face opposing sides in the closed position. The door flange 220 and frame flanges 230 are separated by freely rotating bearings 270 located within the connecting knuckle 240. The rear faces 202 have an off-set ‘X’ surface mounting of the hinges whilst maintaining an accurate closed hinge dimension, being the door gap.

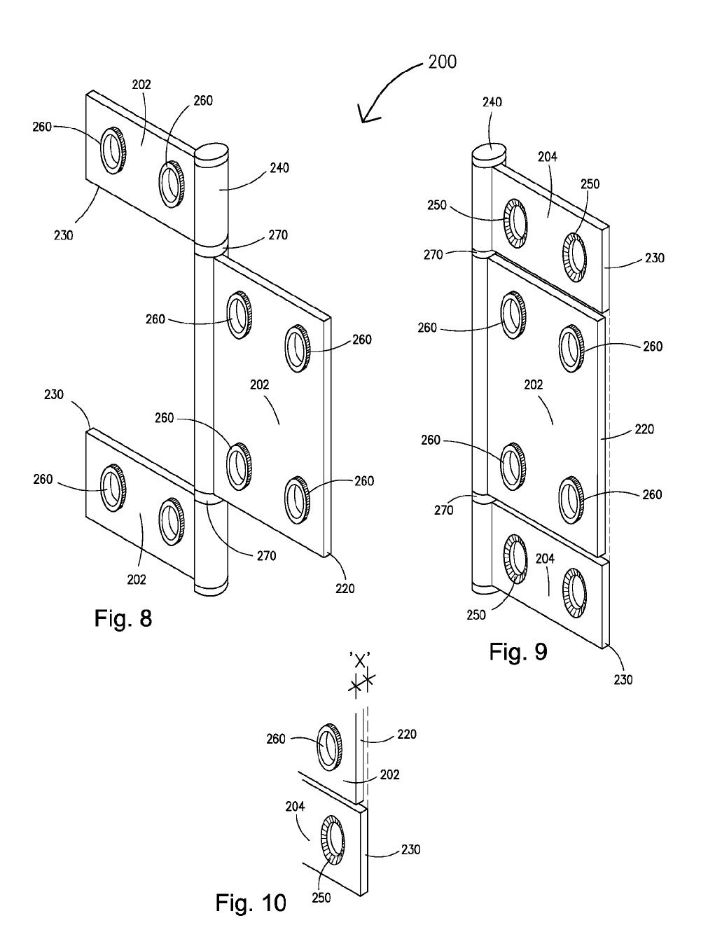

FIG. 8 shows an isometric view of the hinge 200 in an open position with protruding deformation screw holes 260 at the rear face of the flanges facing the same direction.

FIG. 9 shows an isometric view of the hinge 200 in a closed position with front face 204 of frame flange 230 with countersunk screw holes 250 and the rear face 202 of the door flange 220 with protruding deformation screw holes 260.

FIG. 10 shows a detail of the off-set dimension ‘X’ of the closed flanges 220,230 allowing for surface mounting of the hinges with an accurate closed hinge dimension being the door gap.

FIGS. 11 to 20 show an alternative embodiment metal hinge 200b according to a preferred embodiment of the present invention. The hinge 200b also comprises an elongate connecting knuckle 240 to which a door flange 220 and a frame flange 230 are pivotably attached. The flanges are generally equally sized flat plates with the door flange 220 disposed above the frame flange 230. The connecting knuckle extends along an aligned common side edge of the flanges 220 and 230 such that the flanges are pivotable in the horizontal direction in use.

FIG. 11 shows a top view of the alternate metal hinge 200b, in an open position, with the connecting knuckle 240 having a removable pin 280 centrally located between the opposing door flange 220 and the frame flange 230. The flanges contain protruding deformation screw holes 260, to provide positive location of the hinge to the screw holes in the door and door frame. The screw holes 260 in the door flange 220 and the frame flange 230 are respectively disposed symmetrically.

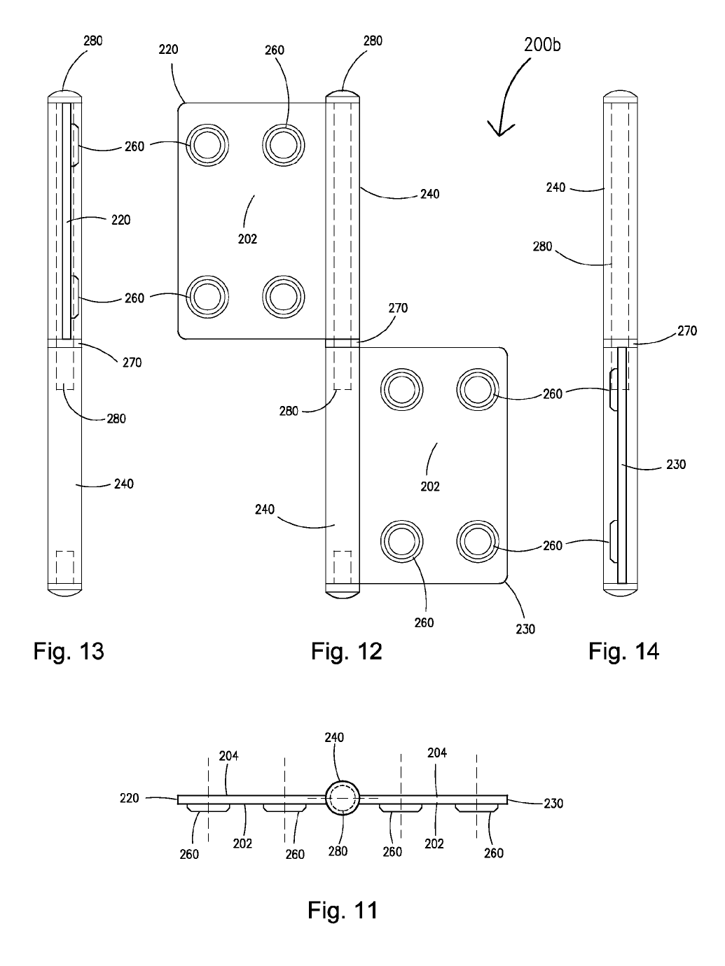

FIG. 12, shows a front view of the alternate metal hinge 200b being in an open position, showing the rear faces 202 of door flange 220 and frame flanges 230 with protruding deformation screw holes 260. In the open position, the rear faces 202 of the flanges 220 and 230 face the same direction. The door flange 220 and frame flange 230 are separated by a freely rotating bearing 270 located within the connecting knuckle 240, which contains a removable pin 280. The removable pin 280 allows the door flange 220 to be separated from the frame flange 230, thus allowing the door to be removed without having to remove the hinge.

FIGS. 13 and 14 show the side view of the alternate metal hinge 200b with the door flange 220 and frame flange 230 having protruding deformation screw holes 260, with connecting pivoting knuckle 240 and removable pin 280 shown dashed.

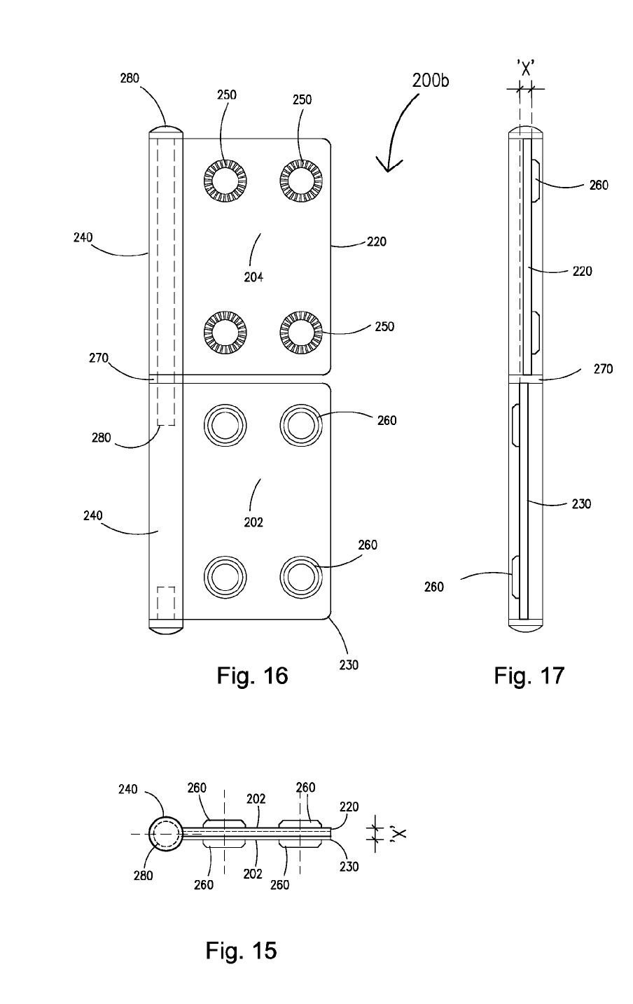

FIG. 15, shows a top view of the alternate metal hinge 200b, in a closed position, with the connecting knuckle 240 housing a removable pin 280 being connected to both door flange 220 and the frame flange 230 with protruding deformation screw holes 260. In the closed position, the rear faces 202 of the flanges 220 and 230 face opposing directions. The rear faces 202 of the flanges 220 and 230 in the closed position are spaced from each other by an off-set ‘X’ that allows for surface mounting of the hinges whilst maintaining an accurate closed hinge dimension door gap.

FIG. 16, shows a front view of the alternate metal hinge 200b being in a closed position, showing the front face of door flange 220 with countersunk screw holes 250 and rear face of the frame flanges 230 with protruding deformation screw holes 260. A freely rotating bearing 270 is located between the door flange 220 and frame flange 230. A connecting knuckle 240 houses a removable pin 280 which allows for the simple separation of the two flanges.

FIG. 17 shows the side view of the alternate closed hinge with door flange 220 frame flange 230 with protruding deformation screw holes 260. The door flange 220 and frame flanges 230 are separated by a freely rotating bearing 270 located within the connecting knuckle 240, which also houses a removable pin 280. The rear surfaces of the closed flanges are off-set ‘X’ to allow for surface mounting of the hinges whilst maintaining an accurate closed hinge dimension door gap.

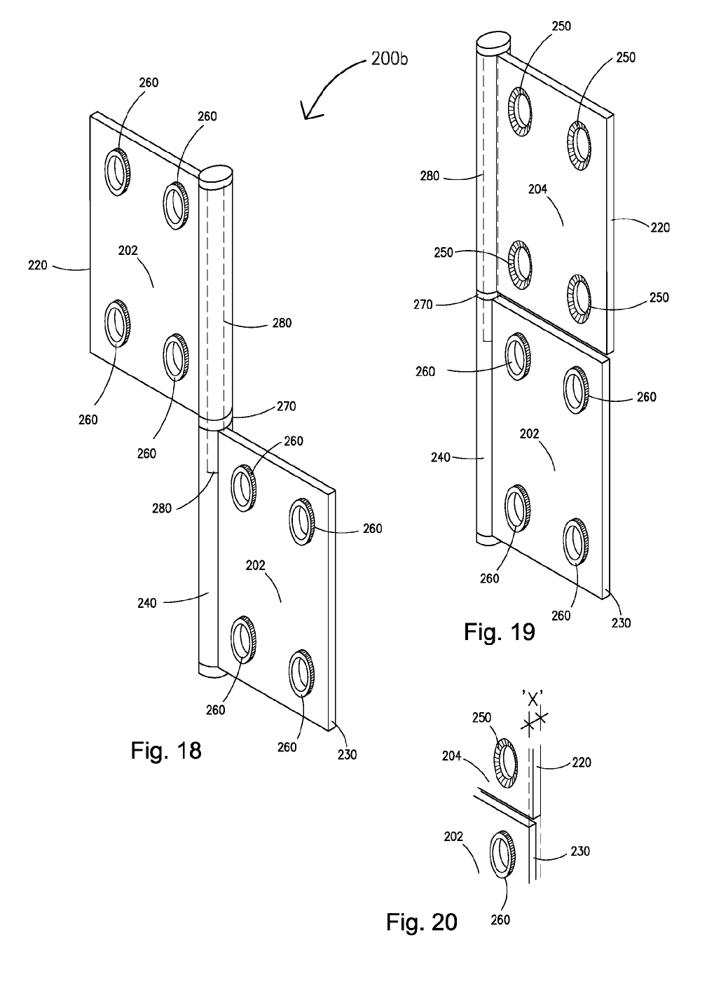

FIG. 18 shows an isometric view of the alternate hinge in an open position with the rear faces of the door flange 220 and frame flange 230 containing protruding deformation screw holes 260.

FIG. 19 shows an isometric view of the alternate hinge in a closed position with front face of door flange 220 with countersunk screw holes 250 and rear face of frame flange 230 with protruding deformation screw holes 260.

FIG. 20 showing a detail of the off-set dimension ‘X’ of the closed flanges 220,230 allowing for surface mounting of the hinges with an accurate closed hinge dimension being the door gap.

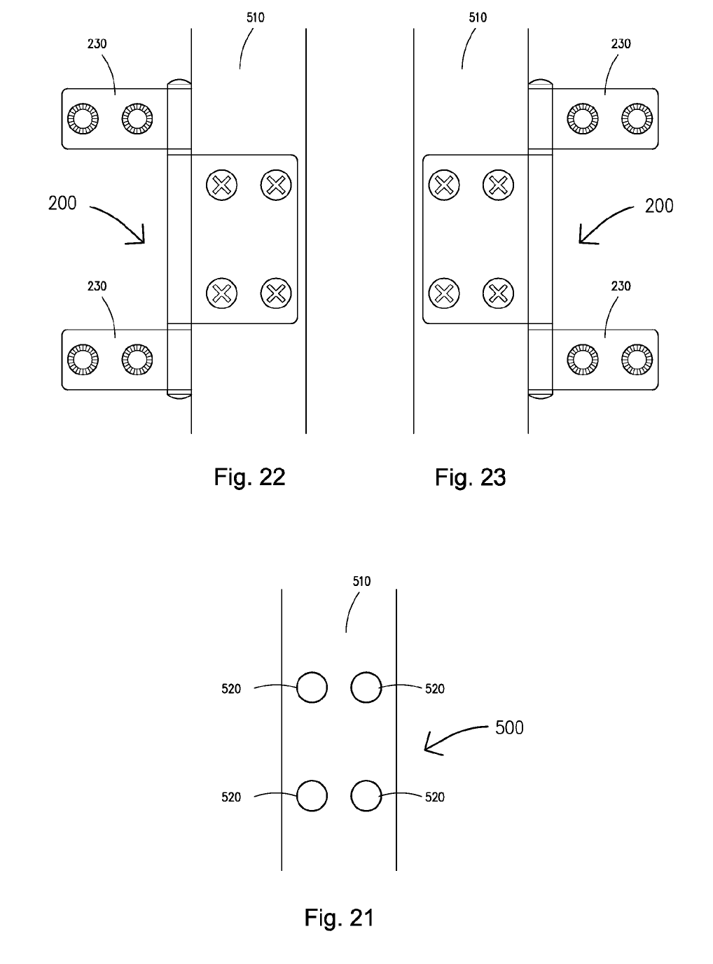

FIG. 21 shows four screw holes 520 formed in the hinge face 510 of a door 500. The door can be made from any material such as wood or metal. FIG. 22 shows attachment of the reversible hinge 200 to the door 500 with the frame flanges 230 extending to one side of the door, and FIG. 23 shows attachment of the reversible hinge 200 to the door 500 with the frame flanges 230 extending to the other side of the door.

The hinge 200 is surface mounted and comprises symmetrically located screw holes, 260 such that when reversed, the screw holes 260 are in perfect alignment, resulting in a reversible hinge enabling the door swing to be changed from a left-hand to a right-hand door swing, or vice versa.

When closed, the hinge flanges are off-set from each other, such that the closed hinge dimension allows for simple surface mounting of the hinge, thus eliminating the need to of a skilled person to recess the hinges for fitment.

The screw holes have protruding deformations from the rear face of the hinge flanges to provide positive locating by fitting tightly within corresponding screw holes in the door. The protruding deformations being tightly fitting within corresponding screw holes in the door spread the load through the hinge, removing the shear load off the individual screws.

The alternative hinge 200b provides a removable pin that enables the hinge to be converted into a lift-off hinge resulting in easy separation of the hinge flanges

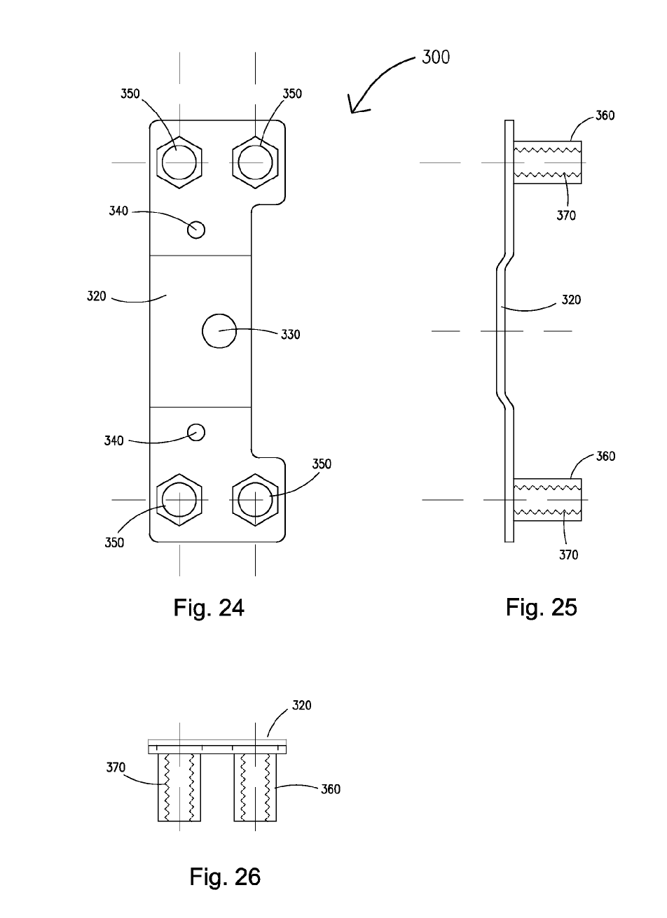

FIGS. 24 to 28 show a hinge reinforcement plate 300 (or stand-off plate 300) which comprises end portions 310 and centre portion 320 offset relative to the end portions 310. The centre portion 320 is thus slightly raised from a surface when the end portions 310 engage a surface. The centre portion 320 contains an access screw hole 330, and two smaller screws holes 340 are provided in the end portions 310 for securing the stand-off plate 300. A number of hexagonal heads 350 which are embedded into the surface of the end portions 310.

Hollow self-clinching spacer pieces 360 extend from the underside of the stand-off plate 300 respectively aligned with the hexagonal head 350. The spacer pieces 360 comprise internal threads 370.

The spacer pieces 360 are disposed to respectively align with the screw holes 260 of the frame flanges 230 in the hinge 200.

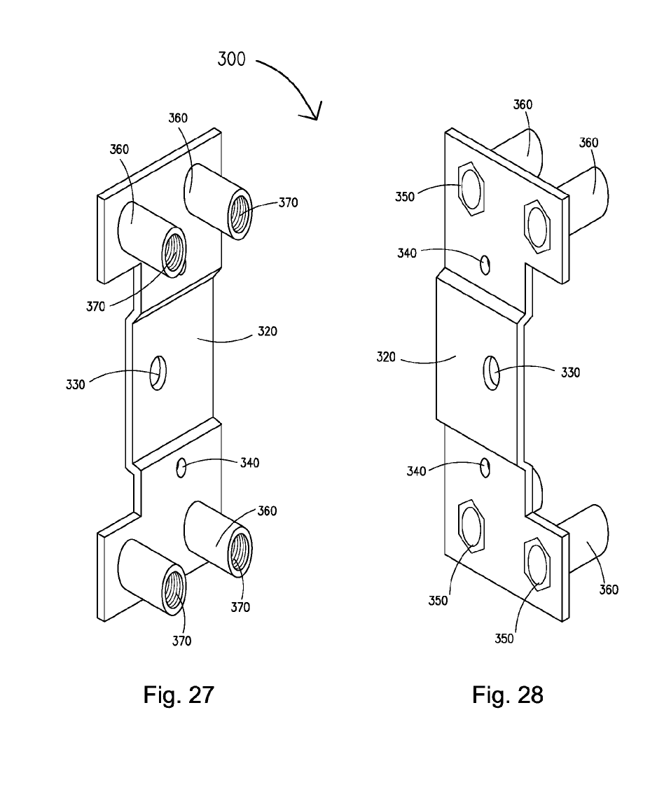

FIG. 27 shows an isometric view of the underside of the stand-off plate 300 with self-clinching spacer pieces 360 having internal machined threads 370.

FIG. 28 shows an isometric view of the topside of the stand-off plate 300 with hexagonal heads 350 embedded into the surface.

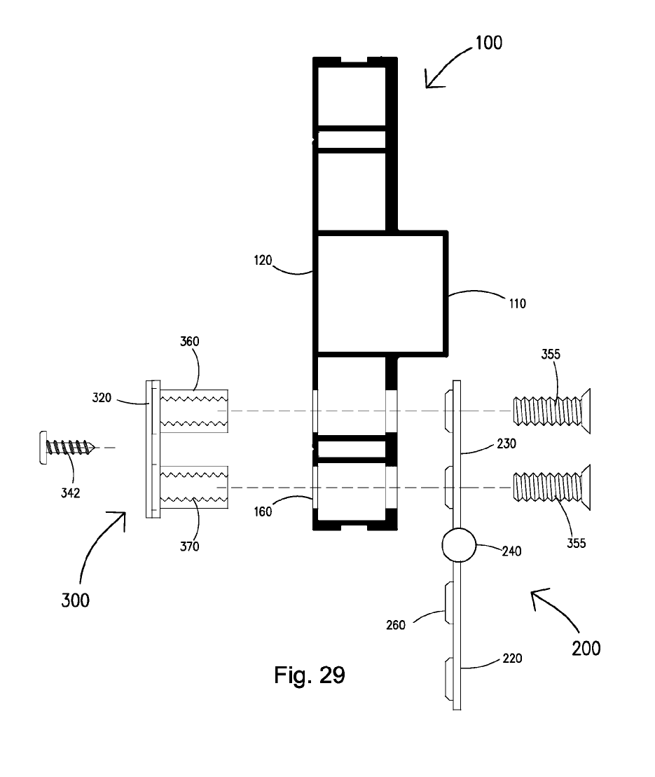

FIGS. 29 to 32 show a reinforced hinge assembly 280 and a door frame section 100. The reinforced hinge assembly comprises the hinge 200 disposed to one side of the door frame 100, the reinforcement plate 300 disposed to the opposite side of the door frame 100, and the components used to secure the stand-off plate 300 to the door hinge 200 through the door frame 100 including machined screws 355.

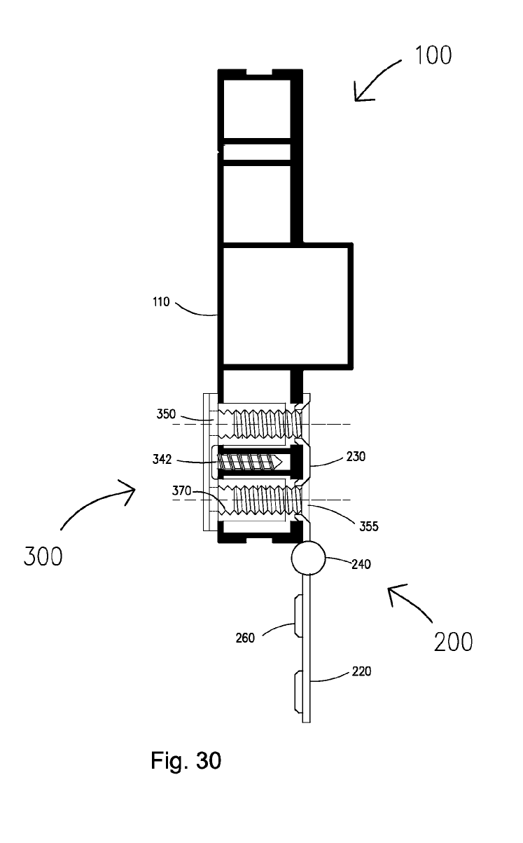

FIG. 30 shows an overhead view of the fitted components having the stand-off plate 300 secured to the door hinge 200 through the door frame 100 via machined screws 355.

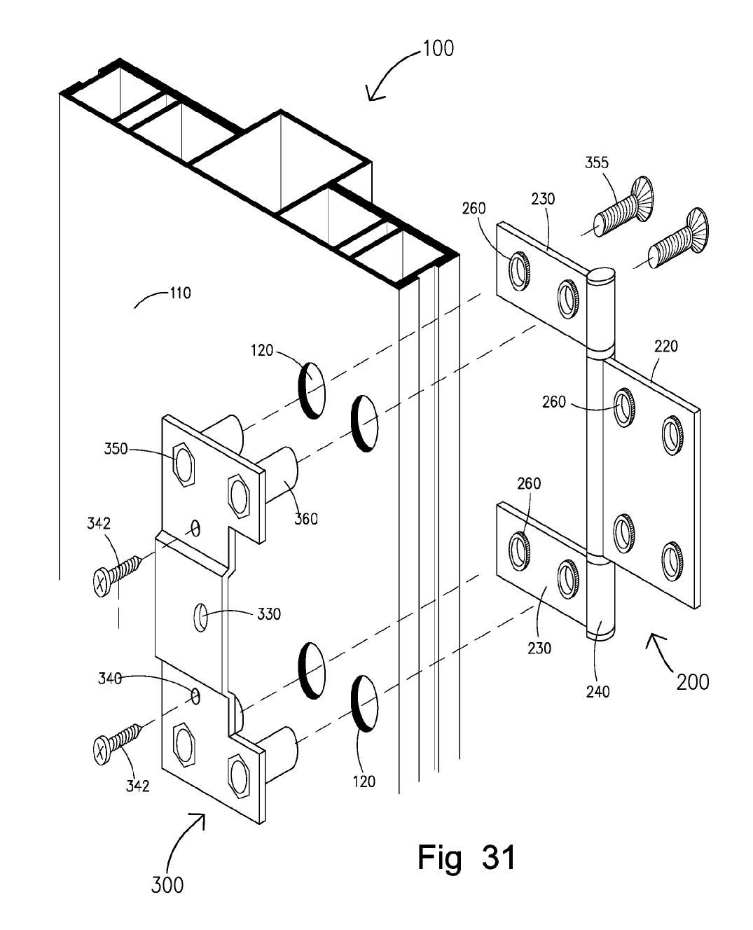

FIG. 31 shows the stand-off plate 300 secured with screws 342 into the door frame 100 through holes 340. The self-clinching spacer pieces 360 are inserted into the holes 120 formed in the rear face 1 10 of the door frame 100. The machined screws 355 pass through the hinge door flange 230 of the hinge 200 and are secured to the stand-off plate 300 via the internal thread 370 of the self-clinching spacer pieces 360.

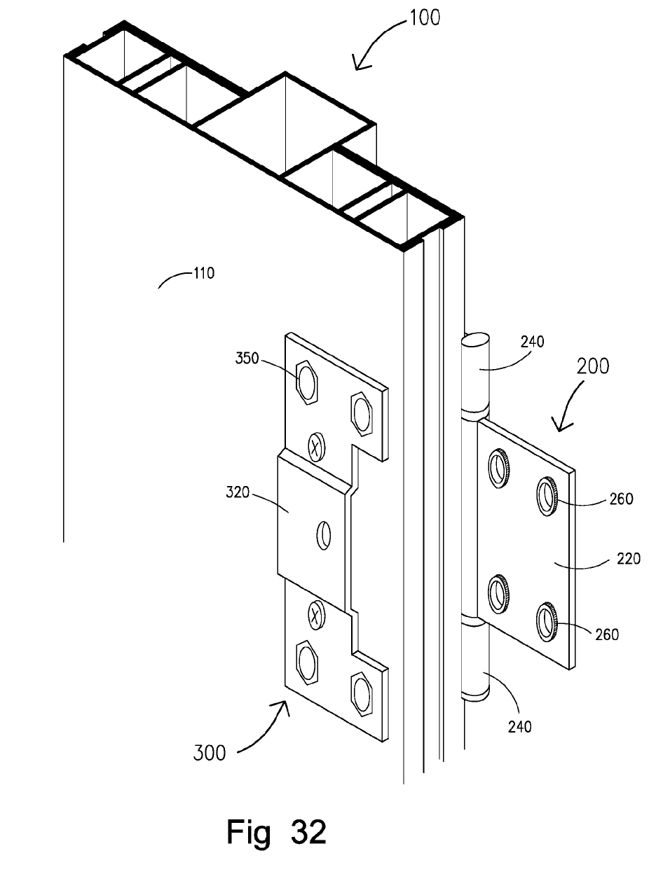

FIG. 32 shows an isometric view of the fitted components with the stand-off plate 300 being secured to the rear face of the door frame 110 via screws 342, with the hinge 200 being tightly fitted to front face of the door frame 100.

The preferred embodiment provides a stand-off plate comprising a number of self clinching spacer pieces which are embedded into the surface of the plate, providing means for securing door hinge screws through the door frame and not into the door frame.

The self-clinching spacer pieces have machined thread inserts that allow for unlimited removal and refitting of screws with no risk of stripping the screw thread or damaging the parent material that would otherwise support the screws.

The machined thread inserts of the self-clinching spacer pieces guarantee that the machined screws are precisely aligned ensuring the screw heads are perfectly flush fitting with the surface of the hinge, and eliminate the possibility of skewed screw heads from screws that have not been inserted properly.

The stand-off plate increases the fixing strength of the hinge and door jamb by spreading the load through the plate and removing the shear load off the individual screws, as the machined screws pull the stand-off plate and hinge tightly together.

The machined threads require only one specific machined screw thread, eliminating the need to have different and specific screw threads when the parent material varies from timber to metal or aluminum.

The preferred embodiment provides a door hinge that is reversible by having symmetrically positioned screw holes that provide the option to reverse the door swing. The screw holes have been located such that reversing the hinge results in the screw holes being in perfect alignment, even after the hinge has been installed on the door edge.

The preferred embodiment eliminates the need for a skilled person to recess the hinges by providing simple surface mounting installation via flanges that are off-set so that when closed, provide an accurate closed hinge dimension, ensuring a consistent door gap.

The preferred embodiment provides positive locating by having the protruding deformations at the rear of the hinge flanges corresponding with the hole locations in the door and frame respectively.

The preferred embodiment removes the shear load off the individual screws by spreading the load through hinge via the protruding deformations tightly fitting into the corresponding holes in the door and frame respectively.

The preferred embodiment provides a stand-off plate with self-clinching spacer pieces for accepting machined screws and providing the means for attaching a door hinge though the door frame, and not into the door frame.

The preferred embodiment provides precisely aligned screws and eliminates the possibility of skewed screw heads resulting from poorly inserted screws.

The preferred embodiment provides allows for unlimited removal and refitting of screws with no risk of stripping the screw thread or damaging the parent material that would otherwise support the screws

The preferred embodiment increases the fixing strength of the hinge and door frame by having the machined screws pulling the stand-off plate and hinge tightly together, thereby spreading the load through the plate and removing the shear load off the individual screws.

The preferred embodiment eliminates the need to have different and specific screw threads, by requiring only one machined screw thread, no matter what the parent material is made from.

The preferred embodiment converts the hinge into a lift-off hinge simply by using a second door flange for use as a frame flange to secure to the frame, with a removable pin located within the central pivoting knuckle allowing easy separation of the hinge flanges.

Whilst preferred embodiments of the present invention have been described, it will be apparent to skilled persons that modifications can be made to the embodiments described.

1. A hinge, comprising:
an elongate connecting knuckle to which at least one door flange and at least one frame flange are pivotably attached, the connecting knuckle extending along aligned side edges of the door flange and the frame flange,
wherein the door flange has a plurality of symmetrically located screw holes such that the screw holes are in alignment with screw holes formed in a door in use with the frame flange disposed on either side of the door, resulting in a reversible hinge enabling the door swing to be changed from a left-hand to a right-hand door swing or vice versa.

2. The hinge of claim 1, comprising two frame flanges, wherein the flanges are rectangular flat plates with the door flange disposed between the two frame flanges.

3. The hinge of claim 1, wherein in the open position of the hinge, rear faces of the flanges face the same direction, the rear faces of the flanges comprising protruding deformation screw holes to provide positive location of the hinge to screw holes in the door and door frame.

4. The hinge of claim 1, wherein the screw holes in the frame flange are disposed symmetrically.

5. The hinge of claim 1, wherein the door flange and frame flanges are separated by freely rotating bearings located within the connecting knuckle.

6. The hinge of claim 1, wherein in the closed position, the rear faces of the door flanges and frame flange face opposing directions.

7. The hinge of claim 6, wherein the rear faces of the door flange and the frame flange in the closed position are spaced from each other by off-set distance.

8. The hinge of claim 1, wherein the front faces of the door flange and frame flange comprise countersunk screw holes.

9. The hinge of claim 1, wherein the door flange and frame flange are equally sized flat plates with the door flange disposed above the frame flange.

10. The hinge of claim 1, wherein the connecting knuckle comprises a removable pin centrally located between the door flange and the frame flange to allow the door flange to be separated from the frame flange.

11. A reinforced hinge assembly comprising:
the hinge according to claim 1, wherein the frame flange is to be disposed to one side of a door frame, and
a reinforcement plate to be disposed to an opposite side of the door frame, the reinforcement plate comprising a shaped plate having a plurality of hollow internally threaded spacer pieces aligned with the screw holes of the frame flange, wherein the spacer pieces are embedded into the door frame in use and provides means for securing hinge screws through the door frame.

12. The hinge assembly of claim 11, wherein the spacer pieces are self-clinching.

13. The hinge assembly of claim 11, wherein the reinforcement plate comprises end portions and a centre portion offset relative to the end portions, wherein the spacer pieces extend from the end portions.
